(19) United States
(12) Patent Application Publication
(10) Pub. No.: US 2004/0201772 A1
(43) Pub. Date: Oct. 14, 2004

(54) Portable electronic apparatus and power source control method therefor

(75) Inventor: Keiichi Kobayashi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/819,505

(22) Filed: Apr. 6, 2004

(30) Foreign Application Priority Data
Apr. 9, 2003 (JP) 2003-104715

(51) Int. Cl. H04N 5/225

(52) U.S. Cl. 348/372

(57) ABSTRACT

A digital camera is provided with a direction sensor which senses a vertical or horizontal direction along a direction of rotation about a predetermined axis of the camera body. When the direction sensor senses that the camera body is changed from a vertically laid state to a horizontally laid state or from a horizontally laid state to a vertical laid state in a power source off state with a predetermined operation mode being set, a control unit switches on the power source. If no operation is made during a short time period after the power source is switched on, the control unit switches off the power source. A user can quickly perform image capturing at a desired timing without having to perform the power source switching on operation, when taking out the digital camera from where it has been put such as a pocket of the clothes.

### BACKGROUND OF THE INVENTION

1. Field of the Invention

The present invention relates to a power source control apparatus and power source control method suitable for electronic apparatuses for portable use such as digital still cameras, PDAs, etc.

2. Description of the Related Art

Conventionally, a technique (for example, Japanese Patent No. 2602214) has been known that electronic apparatuses for portable use such as PDAs are designed such that their power source is so positioned to be easily operable by users or that their power source is automatically on when the foldable casing is unfolded, because it is demanded that the apparatuses can be used immediately after they are taken out from where they have been put.

However, although the above-described conventional electronic apparatuses can be switched on rather smoothly, but time lag is still unavoidable because some operation has to be done after the apparatuses are taken out from where they have been put.

Further, those apparatuses that are switched on automatically in response to vibration have a problem that they are switched on constantly if they are carried around and their battery is used up.

### SUMMARY OF THE INVENTION

The present invention was made in view of the above circumstance, and there are provided an electronic apparatus whose power source is automatically switched on or switched off at a user's desired timing, and a power source control method.

One of the preferred embodiments of the present invention is a portable electronic apparatus comprising: a direction sensing unit which senses a vertical or horizontal direction which is along a direction of rotation about a predetermined axis of an apparatus body; and a control unit which switches on a power source in response to that a direction of the apparatus body sensed by the direction sensing unit changes.

Another one of the preferred embodiments of the present invention is a portable electronic apparatus comprising: a brightness sensing unit which senses brightness of a vicinity of an apparatus body; and a control unit which switches on a power source in response to that the brightness sensed by the brightness sensing unit increases by equal to or greater than a predetermined degree during a predetermined time period.

Yet another one of the preferred embodiments of the present invention is a method of controlling a power source of a portable electronic apparatus, comprising switching on a power source when brightness of a vicinity of an apparatus body increases by equal to or greater than a predetermined degree during a predetermined time period.

Still another one of the preferred embodiments of the present invention is a portable electronic apparatus comprising: a first and second sensing units which sense different information from each other; and a control unit which switches on a power source in response to that sensing results showing predetermined changes in an environment are obtained from both of the first and second sensing units.

Still another one of the preferred embodiments of the present invention is a method of controlling a power source of a portable electronic apparatus, comprising switching on a power source when a control unit determines that a predetermined change in an environment occurs to an apparatus, based on information from first and second sensing units which are different from each other.

### BRIEF DESCRIPTION OF THE DRAWINGS

These objects and other objects and advantages of the present invention will become more apparent upon reading of the following detailed description and the accompanying drawings in which:

FIGS. 1A to 1C are diagrams showing the appearance of a digital camera which is common to each embodiment of the present invention, where FIG. 1A shows the top surface, FIG. 1B shows the back surface, and FIG. 1C shows the front surface;

FIG. 2 is a block diagram showing an electric structure of the digital camera according to a first embodiment of the present invention;

FIG. 3 is an exemplary diagram showing registers provided inside a control unit according to the first embodiment;

FIG. 4 is a flowchart showing an operation of the digital camera in a case where a quick image capturing mode is set according to the first embodiment;

FIG. 5 is a block diagram showing an electric structure of a digital camera according to a second embodiment of the present invention;

FIG. 6 is a flowchart showing an operation of the digital camera in a case where a quick image capturing mode is set according to the second embodiment;

FIG. 7 is a block diagram showing an electric structure of a digital camera according to a third embodiment of the present invention;

FIG. 8 is a flowchart showing an operation of the digital camera in a case where a quick image capturing mode is set according to the third embodiment;

FIG. 9 is a flowchart subsequent to the flowchart of FIG. 8

FIG. 10 is a block diagram showing an electric structure of a digital camera according to a fourth embodiment of the present invention;

FIG. 11 is a flowchart-showing an operation of the digital camera in a case where a quick image capturing mode is set according to the fourth embodiment;

FIG. 12 is a flowchart subsequent to the flowchart of FIG. 11;

FIG. 13 is a block diagram showing an electric structure of a digital camera according to a fifth embodiment of the present invention;

FIG. 14 is a flowchart showing an operation of the digital camera in a case where a quick image capturing mode is set according to the fifth embodiment;

FIG. 15 is a block diagram showing an electric structure of a digital camera according to a sixth embodiment of the present invention; and

FIG. 16 is a flowchart showing an operation of the digital camera in a case where a quick image capturing mode is set according to the sixth embodiment.

### DETAILED DESCRIPTION OF THE PREFERRED EMBODIMENTS

Embodiments where the present invention is applied to a digital camera will now be explained with reference to the drawings.

### First Embodiment

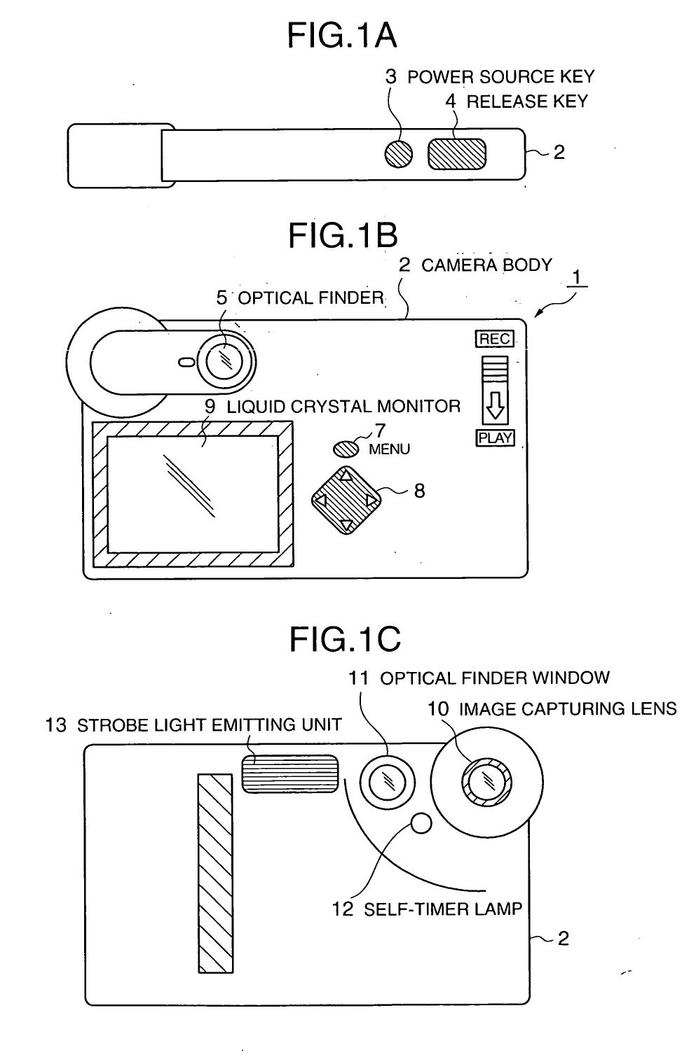

FIGS. 1 show the appearance of a digital camera 1 common to the present embodiment and each of the later-described embodiments, where FIG. 1A shows the structure of the top surface thereof, FIG. 1B shows the structure of the back surface thereof, and FIG. 1C shows the structure of the front surface thereof.

As illustrated, a power source key 3 and a release key 4 are provided near the right end of the top surface of a camera body 2, which is the casing of the digital camera 1 having a plate-like rectangular parallelepiped shape.

The power source key 3 is for switching on or off the power source. The release key 4 is for causing the shuttering operation by an operation thereon when it is a recording mode, and also functions as a selection/execution key when menu items for various operation modes are displayed.

An optical finder 5, a record (REC)/play (PLAY) switch 6, a menu (MENU) key 7, a cursor key 8 for selecting displayed menu items and the like, and a liquid crystal monitor 9 are provided on the back surface of the digital camera 1.

The record/play switch 6 is a slide switch for switching between a recording mode and a play mode. The menu key 7 is for displaying menu items for various operation modes and the like.

The cursor key 8 is for moving the cursor for the displayed menu items and the like. The liquid crystal monitor 9 is constituted by a color liquid crystal display panel with a backlight. The liquid crystal monitor 9 displays the photo-object image (through image) thereon when on standby for image capturing in the recording mode. The liquid crystal monitor 9 also displays which operation mode is selected in response to an operation to the menu key 7.

An image capturing lens 10, an optical finder window 11, a self-timer lamp 12, and a strobe light emitting section 13 are provided on the front surface of the camera body 2. A direction sensor 14 (not shown in FIGS. 1) is provided inside the camera body 2.

The direction sensor 14 is a direction sensing unit of the present invention for sensing in which direction the camera body 2 of the digital camera 1 is oriented. The direction sensor 14 is used for controlling the power source. The direction sensed by the direction sensor 14 is a vertical or horizontal direction along a direction of rotation about an axis which penetrates through the centers of the front surface and back surface of the camera body 2. Such a sensed direction is used for adding a vertical or horizontal flag indicating in which direction a picked-up image has been captured at the time of image capturing. Since the direction sensor 14 is required to function all the time, it is preferred that the direction sensor 14 is a passive sensor which requires no power source for sensing, such as, for example, a ball or the like which selectively opens or closes a vertical switch circuit and a horizontal switch circuit by its movable contact point which is moved in accordance with changes in the direction of the camera body 2.

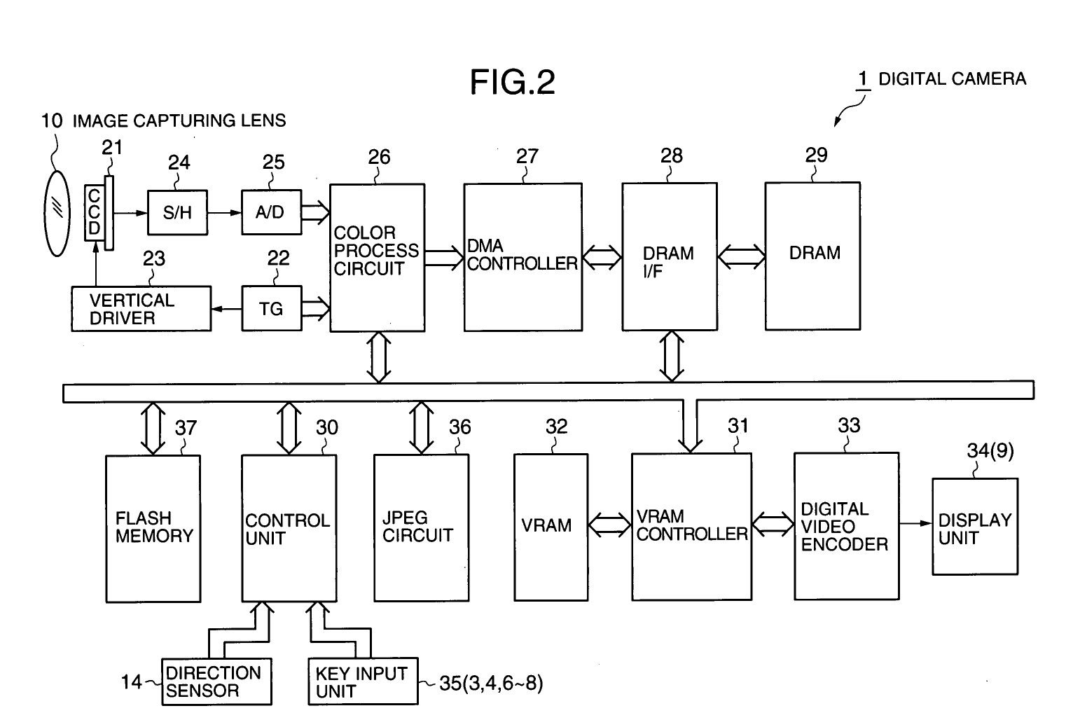

Next, the structure of mainly an electronic circuit provided inside the camera body 2 will be explained with reference to FIG. 2.

As described above, the recording mode and play mode can be switched in the digital camera 1. As shown in FIG. 2, when monitoring is on in the recording mode, a CCD 21 which is an image pickup element arranged behind an image capturing optical axis of the image capturing lens 10 is scan-driven by a timing generator (TG) 22 and a vertical driver 23, thereby outputting an optoelectric conversion output for one screen at each regular interval.

This optoelectric conversion output is obtained by gain-controlling each of R, G, and B primary color components of an analog signal, sample-holding the analog signal by a sample/hold circuit (S/H) 24, converting the analog signal into digital data by an A/D converter 25, and applying a color process including image interpolation to the digital data by a color process circuit 26 thereby generating a luminance signal Y and color difference signals Cb and Cr each having a digital value. The luminance signal Y and the color difference signals Cb and Cr are output to a DMA (Direct Memory Access) controller 27.

The DMA controller 27 writes the luminance signal Y and the color difference signals Cb and Cr output by the color process circuit 26 in a buffer included in the DMA controller 27 by using a composite synchronizing signal, a memory writing enable signal, and a clock signal which are likewise output by the color process circuit 26, and transfers these signals to a DRAM 29 via a DRAM interface (I/F) 28 in a DMA manner.

A control unit 30 reads the luminance signal and color difference signals from the DRAM 29 via the DRAM interface 28 after the luminance signal and color difference signals are transferred to the DRAM 29 in the DMA manner, and writes the signals in a VRAM 32 via a VRAM controller 31.

A digital video encoder (hereinafter abbreviated as “video encoder”) 33 regularly reads the luminance signal and color difference signals from the VRAM 32 via the VRAM controller 31, generates a video signal based on these read data, and outputs the video signal to a display unit 34.

The display unit 34 is constituted by the liquid crystal monitor 9, a drive circuit therefore, and the like. The display unit 34 functions as an EVF (Electronic View Finder) in the recording mode. The display unit 34 displays an image based on image information acquired from the VRAM controller 31 at a given timing, by displaying an image based on a video signal sent from the video encoder 33.

In the state where images are displayed as monitored images by the display unit 34 at corresponding timings in the real time, the release key 4 among a plurality of keys constituting a key input unit 35 is operated at a timing of an image desired to be recorded, thereby generating a trigger signal.

In response to the trigger signal, the control unit 30 stops the route from the CCD 21 to the DRAM 29 immediately after the luminance signal and color difference signals for one screen that are acquired from the CCD 21 at that timing are transferred to the DRAM 29, and changes to a recording state.

In this recording state, the control unit 30 reads the luminance signal and color difference signals for one frame from the DRAM 29 component by component (Y, Cb, Cr) in a unit called basic block including vertical 8 pixels×horizontal 8 pixels, and writes the signals in a JPEG circuit 36. In the JPEG circuit 36, these signals are subjected to data compression by ADCT (Adaptive Discrete Cosine Transform), Huffman coding which is an entropy coding method, and the like. The thusly obtained coded data is read from the JPEG circuit 36 as a data file for one image and written in a flash memory 37 which is a non-volatile memory detachably attached to the digital camera 1 as the recording medium thereof.

When the data compression of the luminance signal and color difference signals for one frame and the writing of the full compressed data in the flash memory 37 are completed, the control unit 30 reopens the route from the CCD 21 to the DRAM 29.

At this time, the control unit 30 generates image data which is obtained by thinning a large number of constituent pixels from the original image data, and stores the generated data as a preview image also called thumbnail image in the flash memory 37 in association with the original image data.

In addition to the release key 4, the above-described key input unit 35 comprises the power source key 3, the record/play switch 6, the menu key 7, the cursor key 8, and the like. Signals generated in response to key operations are directly sent to the control unit 30.

A sensing output from the direction sensor 14 is also directly sent to the control unit 30. The control unit 30 receives these outputs, and performs power source control operations based on an auto power on function and auto power off function to be described layer. That is, the control unit 30 functions as the control unit of the present invention.

In the play mode, the control unit 30 stops the route from the CCD 21 to the DRAM 29, reads specific coded data for one frame from the flash memory 37 in response to image selection made by operating the menu key 7, the cursor key 8, etc. in the key input unit 35, and controls the JPEG circuit 36 to read the coded data. Data expansion is applied to the coded data in the JPEG circuit 36, and the luminance signal and color difference signals representing for one frame representing the data are stored and developed in the VRAM 32 via the VRAM controller 31, in the unit of basic blocks each including vertical 8 pixels×horizontal 8 pixels. Then, the video encoder 33 generates a video signal based on the luminance signal and color difference signals for one frame stored and developed in the VRAM 32, and the display unit 34 displays the image corresponding to the video signal.

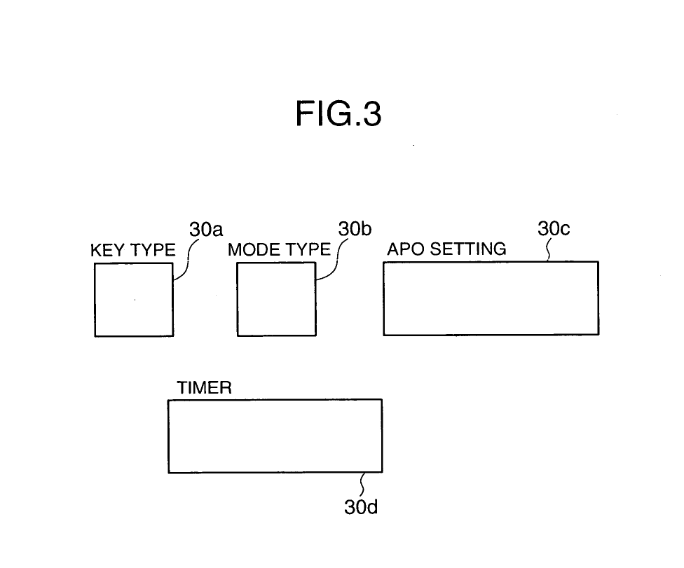

As shown in FIG. 3, there are provided a key type register 30a for retaining the type of an operated key, a mode type register 30b for retaining the type of the mode set at a time concerned, an auto power off (APO) setting register 30c for retaining the time at which the auto power off is executed, and a timer register 30d for counting the time period in which no key is operated.

The mode type register 30b retains the setting for an operation mode which is higher in order than the recording mode and play mode, for example, modes for the auto power on function and auto power off function, and also retains the setting for a detailed operation mode which is lower in order than the recording mode and play mode, for example, whether it is a still picture capturing mode or a moving picture capturing mode when in the recording mode, or modes for setting the white balance including an automatic white balance setting mode. The settings continue to be retained regardless of whether the power source is switched on or off.

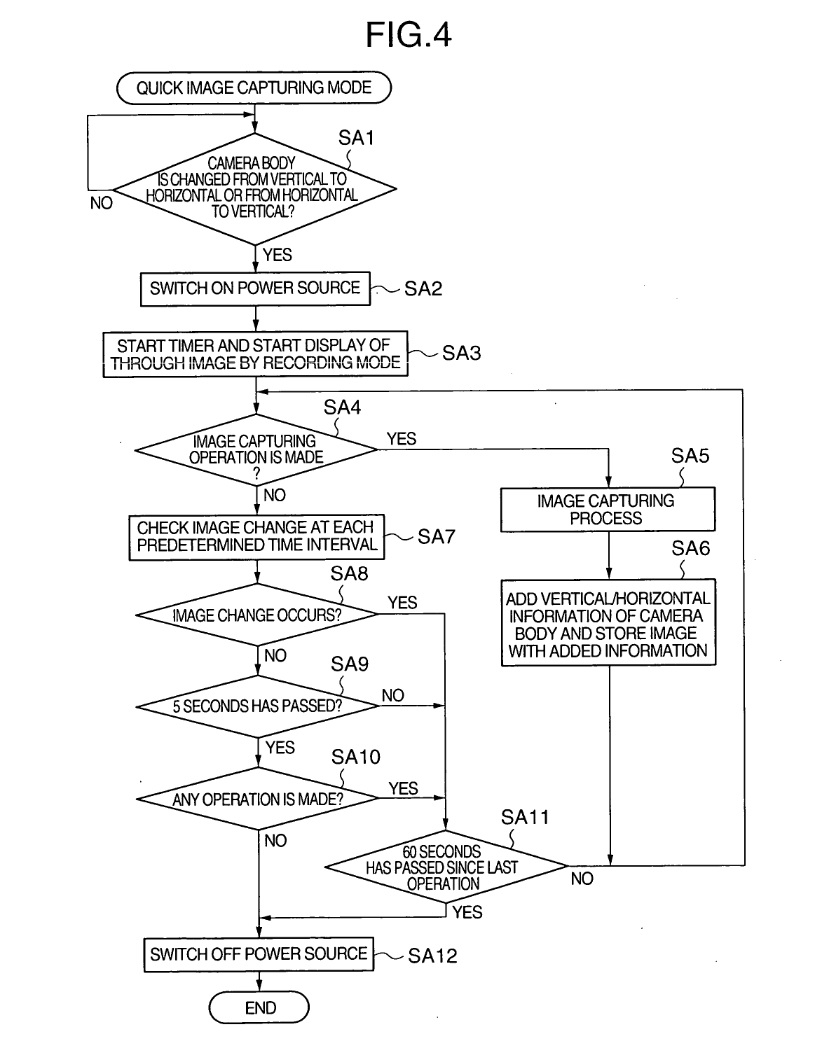

Next, an operation according to the present invention of the digital camera 1 having the above-described structure will be explained with reference to the flowchart shown in FIG. 4. FIG. 4 shows an operation of the digital camera 1 regarding mainly an automatic control on the power source to be performed after the power source is switched off in the state where a quick image capturing mode is set by the user.

When the direction sensor 14 senses that the camera body 2 is changed from a vertically laid state to a horizontally laid state or from a horizontally laid state to a vertically laid state in the power off state (step SA1: YES), this sensing triggers the digital camera 1 to switch on the power source (step SA2). The timer starts counting the time after the power source is switched on, and immediately thereafter the monitor display of a through image is started by an operation for the recording mode (step SA3). After this, if an image capturing operation is performed by the user by depressing the release key 4 (step SA4: YES), an image capturing process including image acquisition by the CCD 21 and compression of the acquired image is performed (step SA5). A sensing result of the direction sensor 14 obtained at this time is added to the captured image as vertical/horizontal information, and the captured image with the added information is stored in the flash memory 37 (step SA6).

In the meantime, after the power source is switched on, a change in the through image is checked at each predetermined time interval (every several seconds) (step SA7). And it is determined whether five seconds has passed after the power source is switched on (step SA9), and it is determined whether any operation is made during the five seconds after the power source is switched on (step SA10). If no change occurs in the through image (step SA8: NO) and if no operation is made during the five seconds after the power source is switched on (step SA10: NO), the power source is then immediately switched off (step SA12). If the through image is continuously changed (step SA8: YES), or if no change occurs in the through image but a certain operation is made during the five seconds after the power source is switched on (step SA10: YES), the power source is maintained to be on. Further, when sixty seconds has passed since the last operation and there is no power source switching off operation by the user during the sixty second, that is, if no operation is made during the sixty seconds (step SA11: YES), the power source is switched off by the general auto power off function (step SA12).

As described above, according to the digital camera 1 of the present embodiment, if the quick image capturing mode is pre-set, the power source is automatically switched on in response to the sensing of the change of the camera body 2 from a vertically laid state to a horizontally laid state or from a horizontally laid state to a vertically laid state, which happens when the camera body 2 is taken out from where it has been put such as a bag or a pocket of the clothes. Accordingly, by pre-setting the quick image capturing mode, the user can capture an image quickly at a desired timing without having to perform the power source switching on operation.

Further, according to the present embodiment, the power source is automatically switched off if no change occurs in the through image and no operation is made during five seconds after the power source is switched on. Therefore, the digital camera 1 is free from its power source being switched on by mistake when the user does not intend to use the digital camera 1, and free from such a power source on state by mistake being maintained. Accordingly, wasteful consumption of the electric power can be prevented and the battery life can be prolonged in the quick image capturing mode.

In the present embodiment, the power source is switched on when the camera body 2 is changed from a vertically laid state to a horizontally laid state and from a horizontally laid state to a vertically laid state. However, the power source may be switched on only when the camera body 2 is changed from a vertically laid state to a horizontally laid state or when the camera body 2 is changed from a horizontally laid state to a vertically laid state.

### Second Embodiment

A second embodiment of the present invention will now be explained. Also in the resent embodiment, the present invention is applied to a digital camera.

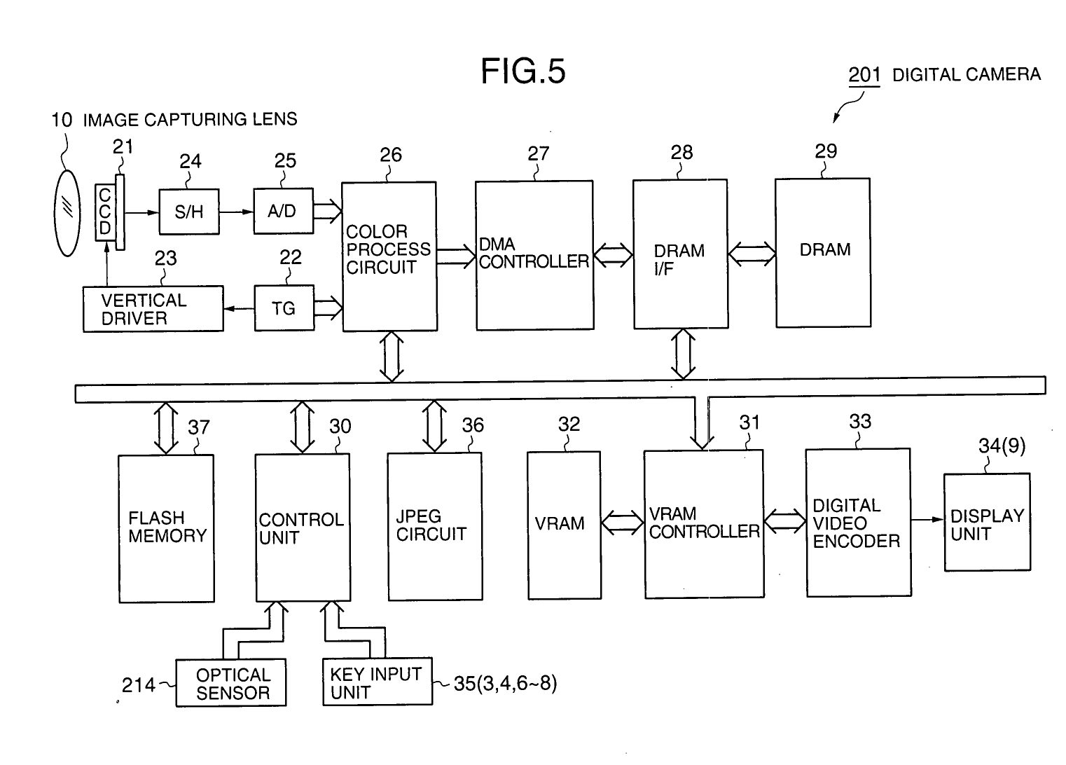

FIG. 5 is a block diagram showing an electrical structure of a digital camera 201 of he present embodiment. The digital camera 201 of the present embodiment is provided with an optical sensor 214 in place of the direction sensor 14 of the first embodiment. The optical sensor 214 is a brightness sensing unit of the present invention for sensing the brightness in the vicinity of the camera body 2. A sensing output of the optical sensor 214 is directly sent to the control unit 30. For example, a photo-conductive cell (CdS cell, etc.), a photodiode, a phototransistor, and an optical cell can be used as the optical sensor 214.

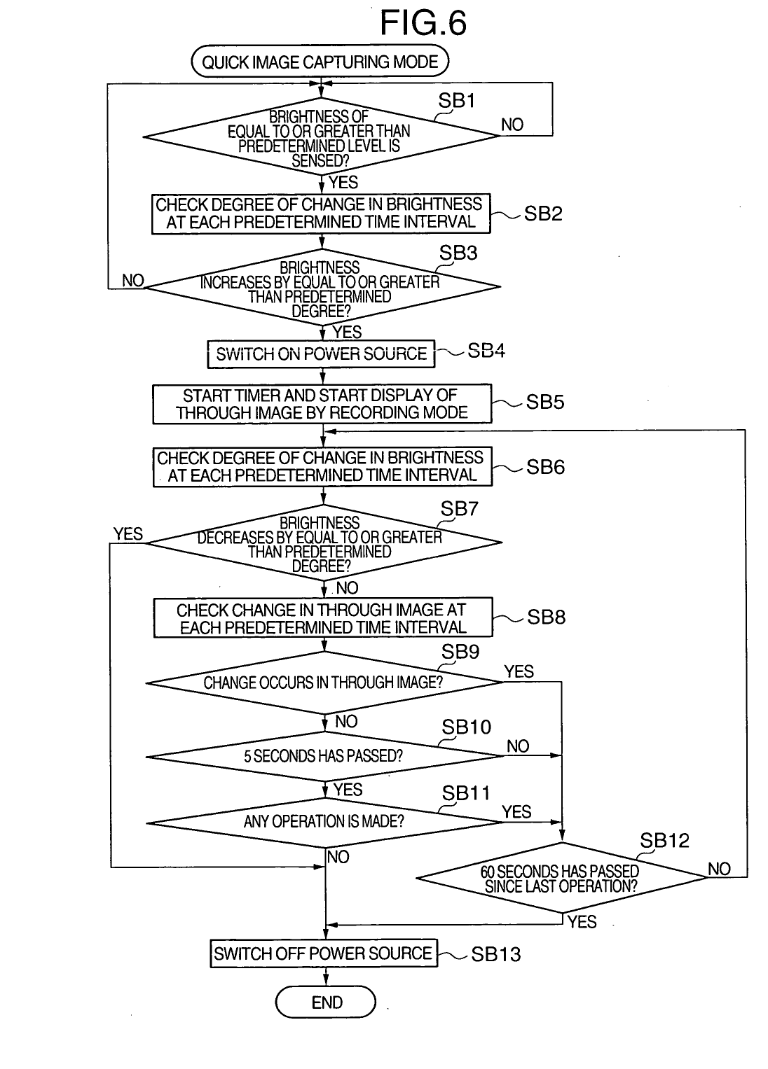

An operation according to the present invention of the digital camera 201 having the above-described structure will be explained with reference to the flowchart shown in FIG. 6. FIG. 6 shows an operation relating to automatic control on the power source of the digital camera 201, which is performed after the power source is switched off in the state where a quick image capturing mode is set by the user.

When the optical sensor 214 senses that the brightness in the vicinity of the camera body 2 becomes equal to or greater than a predetermined level of brightness in the power source off state (step SB1: YES), the digital camera 201 checks the degree of change in the brightness sensed by the optical sensor 214 at each predetermined time interval (for example, every 0.5 second) (step SB2). When it is confirmed that the brightness increases by equal to or greater than a predetermined degree (step SB3: YES), that is, when the vicinity of the camera body 2 suddenly becomes bright, this triggers the power source to be switched on (step SB4). The timer starts counting the time after the power source is switched on, and the digital camera 201 immediately starts the monitor display of a through image by an operation for the recording mode (step SB5).

Even after the power source is switched on, the sensing of the brightness and the checking of the degree of the change in the sensing result are performed at each predetermined time interval (step SB6). When the brightness sensed by the optical sensor 214 decreases by equal to or greater than a predetermined degree from the brightness sensed last (step SB7: YES), that is, when the vicinity of the camera body 2 becomes suddenly dark, this triggers the power source to be switched off (step SB13).

Apart from these operations, after the power source is switched on, a change in the through image is checked at each predetermined time interval (every several seconds) (step SB8) likewise the first embodiment, regardless of the degree of the change in the brightness. If no change occurs in the image (step SB9: NO) and if no operation is made during five seconds after the power source is switched on (step SC10: YES, step SC11: NO), the power source is immediately switched off (step SB13). Further, when sixty seconds has passed since the last operation and there is no power source switching off operation by the user during the sixty second, that is, if no operation is made during the sixty seconds (step SB12: YES), the power source is switched off by the general auto power off function (step SB13).

As described above, according to the digital camera 201 of the present embodiment, if the quick image capturing mode is pre-set, the power source is automatically switched on in response to the sensing of a sudden increase in the brightness of the vicinity of the camera body 2, which happens when the digital camera 201 is taken out from where it has been put so far such as a bag or a pocket of clothes, etc. Therefore, by pre-setting the quick image capturing mode, the user can perform image capturing quickly at a desired timing without having to perform the power source switching on operation.

According to the present embodiment, the power source is automatically switched off if no change occurs in the through image and no operation is made during five seconds after the power source is switched on, likewise the first embodiment. Therefore, the digital camera 201 is free from its power source being switched on by mistake when the user does not intend to use the digital camera 201, and free from such a power source on state by mistake being maintained. Thus, wasteful consumption of the electric power can be prevented, and the battery life can be prolonged in the quick image capturing mode.

Further, according to the present embodiment, a sudden darkening of the vicinity of he camera body 2 triggers the power source to be automatically switched off, even before the general auto power off function works due to that the time period during which no operation is made reaches 60 seconds. Accordingly, the user needs only to put the digital camera 201 in the bag or the pocket of the clothes, etc. and, conveniently, needs not to perform the power source switching off operation after using the digital camera 201. Further, as compared to the case where the power source is automatically switched off only by the general auto power off function, wasteful consumption of the electric power can be prevented more. This also contributes to the prolongation of the battery life in he quick image capturing mode. The auto power off function for switching off the power source in response to a sensing result of the optical sensor 214 which acts as a trigger, may solely be used in a state where the quick image capturing mode is not set. Also in this case, wasteful consumption of the electric power can further be prevented.

In the present embodiment, the brightness in the vicinity of the camera body 2 is sensed by the optical sensor 214. However, the optical sensor 214 may not be used but the CCD 21 may be used as the brightness sensing unit of the present invention instead, and an output signal from the CCD 21 may trigger the power source to be switched on or off. Further, in this case, a timer function may be provided in the digital camera 201, so that the reference level of the brightness for switching on or off the power source is changed in accordance with the time zone (for example, in order to switch on the power source in the nighttime even if it is a bit dark, or in order to switch off the power source in the nighttime even if the degree of decrease in the brightness is small). With this structure, the change to the state where the use of the digital camera 201 can be started or he change to the state where the use of the digital camera 201 should be ended can be sensed more accurately, and a more comfortable usage environment can be achieved.

### Third Embodiment

A third embodiment of the present invention will now be explained. Also in the present embodiment, the present invention is applied to a digital camera.

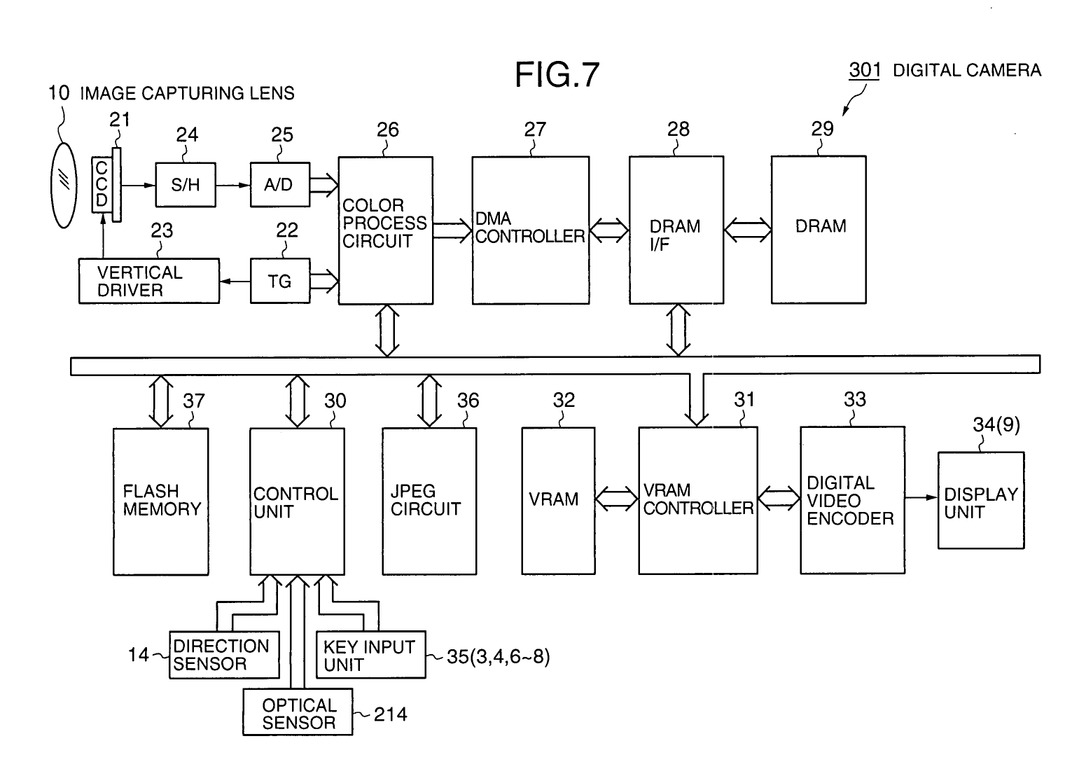

FIG. 7 is a block diagram showing the electric structure of a digital camera 301 of the present embodiment. The digital camera 301 has a structure in which the direction sensor 14 explained in the first embodiment and the optical sensor 214 explained in the second embodiment are provided. Other than this point, the digital camera 301 has the same structure as the first embodiment.

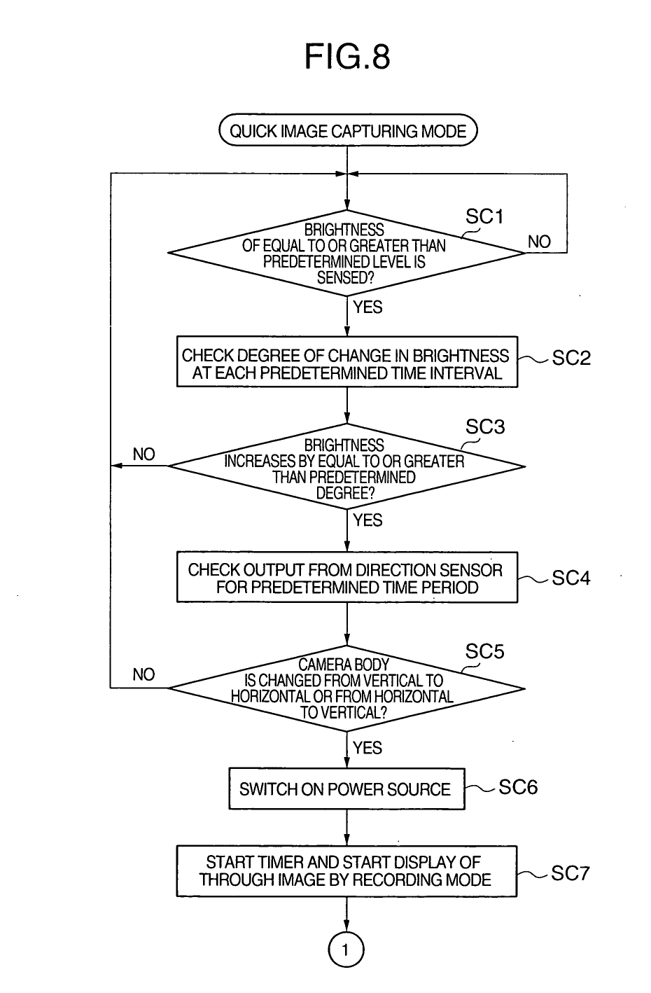

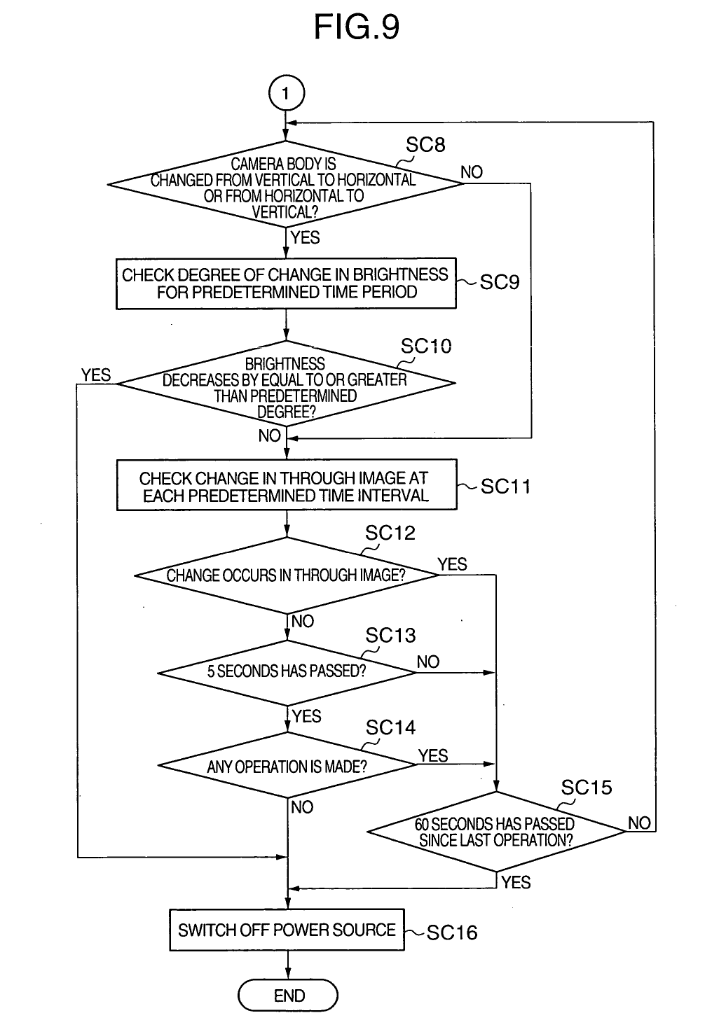

An operation according to the present invention of the digital camera 301 having the above-described structure will now be explained with reference to the flowcharts shown in FIG. 8 and FIG. 9. FIG. 8 and FIG. 9 show an operation regarding power source control of the digital camera 301 which is performed after the power source is switched off in the state where a quick image capturing mode is set.

When the optical sensor 214 senses that the brightness in the vicinity of the camera body 2 becomes equal to or greater than a predetermined level of brightness in the power source off state (step SC1: YES), thereafter the digital camera 301 checks the degree of change in the brightness sensed by the optical sensor 214 at each predetermined time interval (for example, every 0.5 second) (step SC2). When it is confirmed that the brightness increases by equal to or greater than a predetermined degree (step SC3: YES), that is, when the vicinity of the camera body 2 becomes suddenly bright, the digital camera 301 checks the output of the direction sensor 14 for a predetermined time period (several seconds) after this confirmation of the increase in the brightness (step SC4). Then, if it is not sensed that the camera body 2 is changed from a vertically laid state to a horizontally laid state, or from a horizontally laid state to a vertically laid state (step SC5: NO), the power source off state is maintained. On the contrary, if a change of the state of the camera body 2 is sensed (step SC5: YES), this triggers the power source to be switched on (step SC6). Then, the timer starts counting the time after the power source is switched on, and the monitor display of a through image is immediately started by the operation for the recording mode (step SC7).

Then, as shown in FIG. 9, when the direction sensor 14 senses that the camera body is changed from a vertically laid state to a horizontally laid state or from a horizontally laid state to a vertically laid state after the power source is switched on (step SC8: YES), he digital camera 301 checks the degree of change in the brightness for a predetermined time period after the sensing (step SC9). If the brightness decreases by equal to or greater than a predetermined degree during the predetermined time period (step SC10: YES), that is, if the vicinity of the camera body 2 becomes suddenly dark, this triggers the power source to be switched off (step SC16).

Apart from these operations, after the power source is switched on, the digital camera 301 checks a change in the through image at each predetermined time interval (every several seconds) (step SC11) regardless of the change of the state of the camera body 2 likewise the second embodiment. If no change occurs in the through image (step SC12: NO) and if no operation is made during five seconds after the power source is switched on (step SC13: YES, step SC14: NO), the power source is immediately switched off (step SC16). Further, if no operation is made during 60 seconds (step SC15: YES), the power source is switched off by the general auto power off function (step SC16).

As described above, according to the digital camera 301 of the present embodiment, if the quick image capturing mode is pre-set, the power source is automatically switched on in response to the sensing of a sudden increase in the brightness of the vicinity of the camera body 2 due to the camera body 2 being taken out from a bag, a pocket of clothes or the like, and in response to the sensing of a change of the camera body 2 from a vertically laid state to a horizontally laid state or from a horizontally laid state to a vertically laid state. Therefore, by pre-setting the quick image capturing mode, the user can perform image capturing quickly at a desired timing without having to perform the power source switching on operation.

Further, according to the present embodiment, if no change occurs in the through image and no operation is made during five seconds after the power source is switched on, the power source is automatically switched off likewise the first embodiment and second embodiment. Therefore, the digital camera 301 is free from its power source being switched on by mistake when the user does not intend to use the digital camera 301, and free from such a power source on state by mistake being maintained. Accordingly, wasteful consumption of the electric power can be prevented, and the battery life can be prolonged in the quick image capturing mode.

Further, according to the present embodiment, a sudden decrease in the brightness of the vicinity of the camera body 2 after the camera body 2 is changed from a vertically laid state to a horizontally laid state or from a horizontally laid state to a vertically laid state, triggers the power source to be automatically switched off, even before the general auto power off function works due to that the time period during which no operation is made reaches 60 seconds. Accordingly, the user needs only to put the digital camera 301 in the bag or the pocket of the clothes, etc. and, conveniently, needs not to perform the power source switching off operation after using the digital camera 301, likewise the second embodiment. Further, as compared to the case where the power source is automatically switched off only by the general auto power off function, wasteful consumption of the electric power can be prevented more. This also contributes to the prolongation of the battery life in the quick image capturing mode. The auto power off function for switching off the power source in response to sensing results of the direction sensor 14 and the optical sensor 214 may solely be used in a state where the quick image capturing mode is not set. Also in this case, wasteful consumption of the electric power can further be prevented.

Further, according to the present embodiment, unlike the first embodiment and second embodiment, a change of the environment of the digital camera 301 is sensed based on, as described above, the sensing results of the direction sensor 14 and the optical sensor 214, that is, based on information from different sources in order to determine a change to the state where the use of the digital camera 301 can be started or a change to the state where the use of the digital camera 301 should be ended. Accordingly, it is possible to accurately sense a change to the state where the use of the digital camera 301 can be started or a change to the state where the use of the digital camera 301 should be ended, and therefore to achieve a more comfortable usage environment.

Also in the present embodiment, the optical sensor 214 may not be used but the CCD 21 may be used as the brightness sensing unit of the present invention, and the reference level of brightness for switching on or off the power source may be changed in accordance with the time zone, as explained in the second embodiment.

### Fourth Embodiment

A fourth embodiment of the present invention will now be explained. Also in the present embodiment, the present invention is applied to a digital camera.

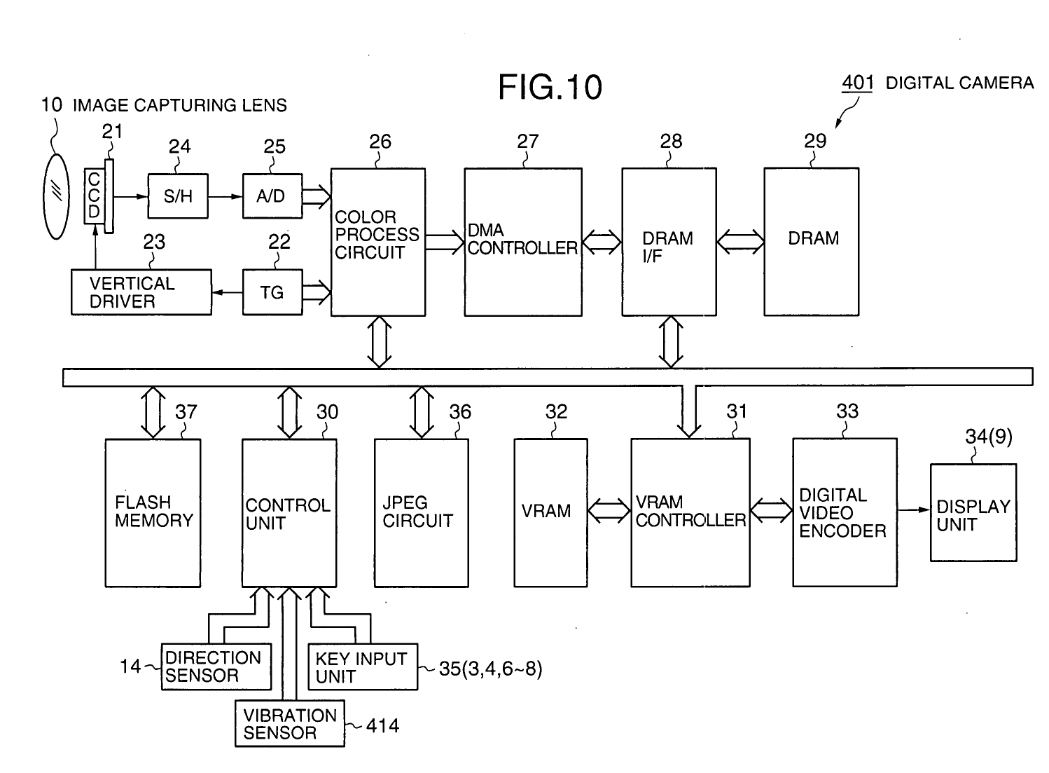

FIG. 10 is a block diagram showing the electric structure of a digital camera 401 according to the present embodiment. The digital camera 401 comprises a vibration sensor 414 in addition to the structure of the digital camera 1 of the first embodiment. The vibration sensor 414 is a vibration sensing unit of the present invention for sensing a vibration of the camera body 2. A sensing output of the vibration sensor 414 is directly sent to the control unit 30. A well known acceleration sensor, etc. used in an electronic wristwatch, etc. can be used as the vibration sensor 414. The other structure than this is the same as the structure explained in the first embodiment.

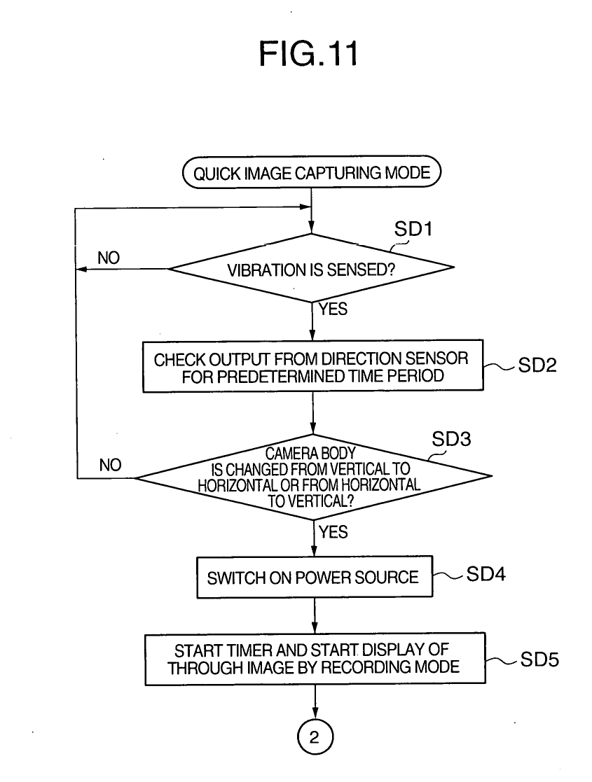

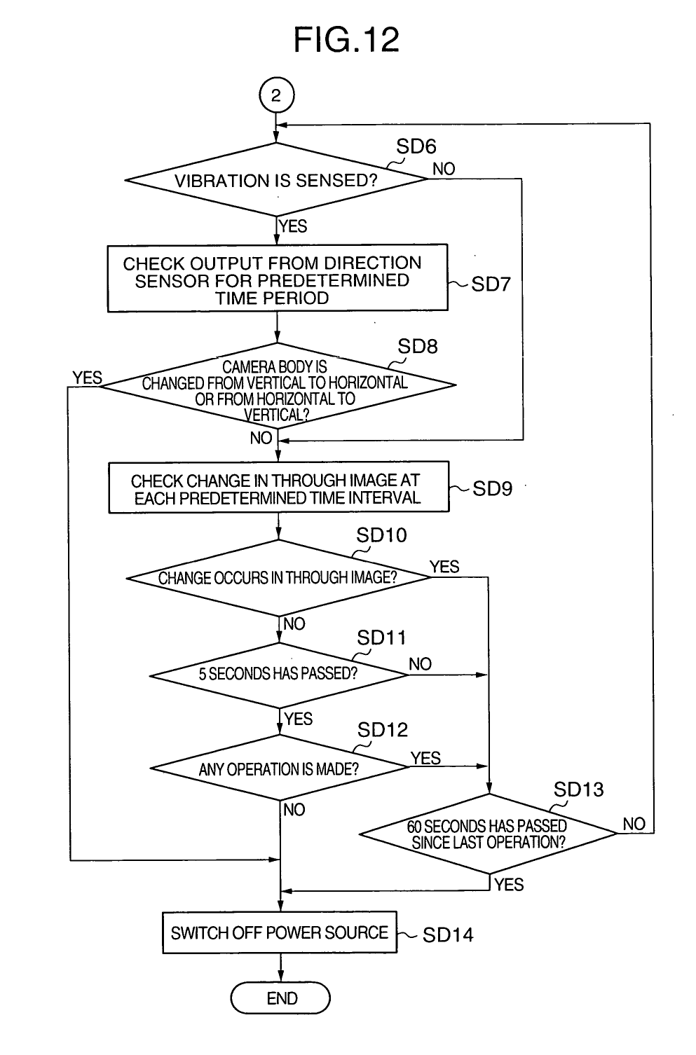

An operation according to the present invention of the digital camera 401 having the above-described structure will now be explained with reference to the flowcharts shown in FIG. 11 and FIG. 12. FIG. 11 and FIG. 12 show the operation regarding the power source control of the digital camera 401 which is performed after the power source is switched off in the state where a quick image capturing mode is set by the user.

When the vibration sensor 414 senses a vibration in the power source off state (step SD1: YES), the digital camera 401 checks an output from the direction sensor 14 for a predetermined time period (for several seconds) from the sensing of the vibration (step SD2). If it is not sensed that the camera body 2 is changed from a vertically laid state to a horizontally laid state or from a horizontally laid state to a vertically laid state during the time period (step SD3: NO), the power source off state is maintained. On the contrary, if a change of the state of the camera body 2 is detected during the time period (step SD3: YES), this triggers the power source to be switched on (step SD4). Then, the timer starts counting the time after the power source is switched on, and the monitor display of a through image is immediately started by an operation for the recording mode (step SD5).

Then, as shown in FIG. 12, if a vibration is sensed by the vibration sensor 414 even after the power source is switched on (step SD6: YES), the digital camera 401 checks an output from the direction sensor 14 for a predetermined time period (for several seconds) after the sensing of the vibration (step SD7). If it is sensed that the camera body 2 is 15 changed from a vertically laid state to a horizontally laid state or from a horizontally laid state to a vertically laid state during the time period (step SD8: YES), this triggers the power source to be switched off (step SD14).

Apart from these operations, after the power source is switched on, the digital camera 401 checks a change in the through image at each predetermined time interval (every several seconds) (step SD9) regardless of whether there is a vibration or not, likewise the second embodiment and third embodiment. If no change occurs in the through image (step SD10:NO) and if no operation is made during five seconds after the power source is switched on (step SD11: YES, step SD12: NO), the digital camera 401 immediately switches off the power source (step SD14). Further, if no operation is made during sixty seconds (step SD13: YES), the power source is switched off by the general auto power off function (step SD14).

As described above, according to the digital camera 401 of the present embodiment, if the quick image capturing mode is pre-set, the power source is automatically switched on in response to the sensing of a vibration of the camera body 2 when the digital camera 401 is taken out from a bag or pocket of clothes, etc. and in response to the sensing of the camera body 2 being changed from a vertically laid state to a horizontally laid state or from a horizontally laid state to a vertically laid state. Accordingly, by pre-setting the quick image capturing mode, the user can quickly perform image capturing at a desired timing without having to perform the power source switching on operation.

Also according to the present embodiment, the power source is automatically switched off if no change occurs in the through image and no operation is made during five seconds after the power source is switched on, likewise the first to third embodiments. Therefore, the digital camera 401 is free from its power source being switched on by mistake when the user does not intend to use the digital camera 401, and free from such a power source on state by mistake being maintained. Accordingly, wasteful consumption of the electric power can be prevented and the battery life can be prolonged in the quick image capturing mode.

Further, according to the present embodiment, a vibration of the camera body 2 and a subsequent change of the state of the camera body 2 from a vertically laid state to a horizontally laid state or from a horizontally laid state to a vertically laid state, trigger the power source to be automatically switched off, even before the general auto power off function works due to that the time period during which no operation is made reaches 60 seconds. Accordingly, the user needs only to put the digital camera 401 in the bag or the pocket of the clothes, etc. and, conveniently, needs not to perform the power source switching off operation after using the digital camera 401, likewise the second embodiment and the third embodiment. Further, as compared to the case where the power source is automatically switched off only by the general auto power off function, wasteful consumption of the electric power can be prevented more. This also contributes to the prolongation of the battery life in the quick image capturing mode.

The auto power off function for switching off the power source in response to sensing results of the vibration sensor 414 and the direction sensor 14 may solely be used in a state where the quick image capturing mode is not set. Also in this case, wasteful consumption of the electric power can further be prevented.

Further, also according to the present embodiment, unlike the first embodiment and second embodiment, a change of the environment of the digital camera 401 is sensed based on, as described above, the sensing results of the vibration sensor 414 and the direction sensor 14, that is, based on information from different sources in order to determine a change to the state where the use of the digital camera 401 can be started or a change to the state where the use of the digital camera 401 should be ended. Accordingly, it is possible to accurately sense a change to the state where the use of the digital camera 401 can be started or a change to the state where the use of the digital camera 401 should be ended, and therefore to achieve a more comfortable usage environment.

### Fifth Embodiment

A fifth embodiment of the present invention will now be explained. Also in the present embodiment, the present invention is applied to a digital camera.

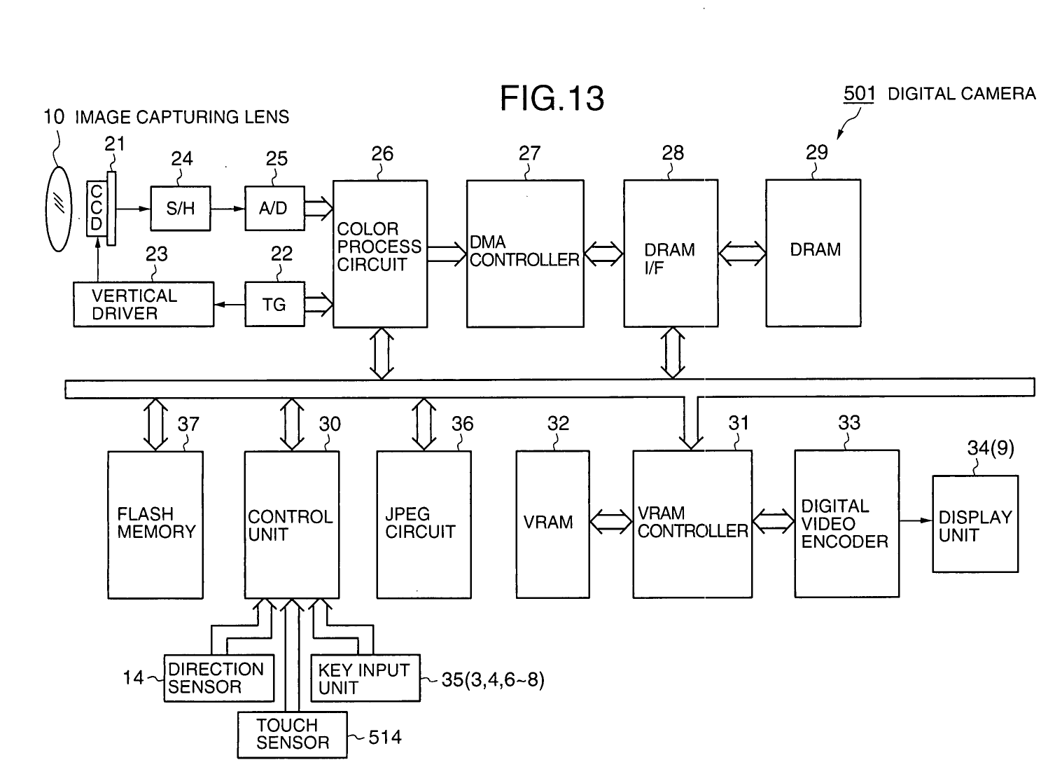

FIG. 13 is a block diagram showing the electric structure of a digital camera 501 according to the present embodiment. The digital camera 501 comprises a touch sensor 514 in addition to the structure of the digital camera 1 explained in the first embodiment. The touch sensor 514 is a touch sensor unit of the present invention for sensing that the user's hand touches one or a plurality of predetermined portions of the circumferential surface of the camera body 2 (or wherever on the circumferential surface thereof). A sensing output of the touch sensor 514 is directly sent to the control unit 30. The other structure than this is the same as the structure explained in the first embodiment.

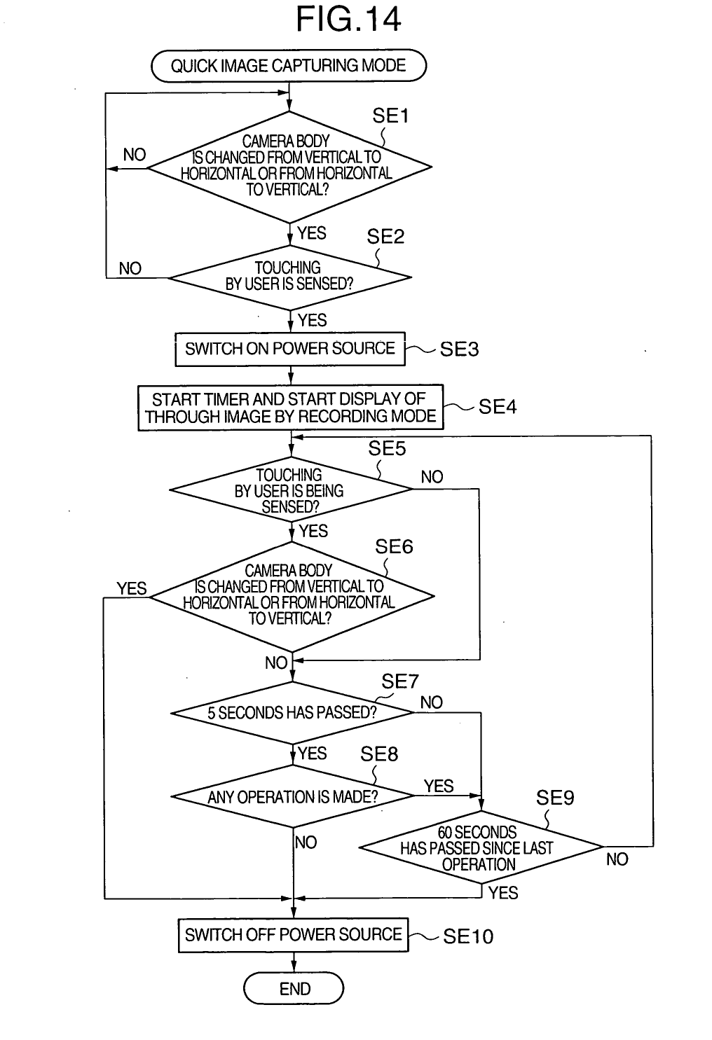

An operation according to the present invention of the digital camera 501 having the above-described structure will now be explained with reference to the flowchart shown in FIG. 14. FIG. 14 shows an operation regarding the power source control of the digital camera 501 which is performed after the power source is switched off in the state a quick image capturing mode is set by the user.

When the direction sensor 14 senses that the camera body 2 is changed from a vertically laid state to a horizontally laid state or from a horizontally laid state to a vertically laid state in the power source off state (step SE1: YES), the digital camera 501 determines whether or not the touch sensor 514 senses touching by the user to the camera body 2. If touching is not sensed (step SE2: NO), the power source off state is maintained. On the contrary, if touching is sensed (step SE2: YES), this triggers the power source to be switched on (step SE3). Then, the timer starts counting the time after the power source is switched on, the monitor display of a through image is immediately started by an operation for the recording mode (step SE4).

Even after the power source is switched on, the touch sensor 514 continues to sense touching by the user. While touching is being sensed (step SE5: YES), if the direction sensor 14 senses that the camera body 2 is changed from a vertically laid state to a horizontally laid state or from a horizontally laid state to a vertically laid state (step SE6: YES), this triggers the power source to be switched off (step SE 10).

Apart from these operations, if no operation is made during five seconds after the power source is switched on (step SE7: YES, step SE8: NO) regardless of whether the camera body 2 is touched by the user or not, the power source is immediately switched off (step SE10). Further, if no operation is made during sixty seconds (step SE9: YES), the power source is switched off by the general auto power off function (step SE10).

As described above, according to the digital camera 501 of the present embodiment, if the quick image capturing mode is pre-set, the power source is switched on automatically in response to the sensing of touching of the user's hand to the camera body 2 when the digital camera 501 is taken out from a bag or a pocket of clothes, etc. and in response to the sensing of the camera body 2 being changed from a vertically laid state to a horizontally laid state or from a horizontally laid state to a vertically laid state. Therefore, by pre-setting the quick image capturing mode, the user can perform image capturing quickly at a desired timing without having to perform the power source switching on operation.

The power source is automatically switched off if no operation is made during five seconds after the power source is switched on. Therefore, the digital camera 501 is free from its power source being switched on by mistake when the user does not intend to use the digital camera 501, and free from such a power source on state by mistake being maintained. Thus, wasteful consumption of the electric power can be prevented and the battery life can be prolonged in the quick image capturing mode.

Further, according to the present embodiment, a change of the state of the camera body 2 from a vertically laid state to a horizontally laid state or from a horizontally laid state to a vertically laid state while the user is touching the camera body 2, triggers the power source to be automatically switched off, even before the general auto power off function works due to that the time period during which no operation is made reaches 60 seconds. Accordingly, the user needs only to put the digital camera 501 in the bag or the pocket of the clothes, etc. and, conveniently, needs not to perform the power source switching off operation after using the digital camera 501, likewise the second to fourth embodiments. Further, as compared to the case where the power source is automatically switched off only by the general auto power off function, wasteful consumption of the electric power can be prevented more. This also contributes to the prolongation of the battery life in the quick image capturing mode. The auto power off function for switching off the power source in response to sensing results of the touch sensor 514 and the direction sensor 14 may solely be used in a state where the quick image capturing mode is not set. Also in this case, wasteful consumption of the electric power can further be prevented.

Further, also according to the present embodiment, unlike the first embodiment and second embodiment, a change of the environment of the digital camera 501 is sensed based on, as described above, the sensing results of the touch sensor 514 and the direction sensor 14, that is, based on information from different sources in order to determine a change to the state where the use of the digital camera 501 can be started or a change to the state where the use of the digital camera 501 should be ended. Accordingly, it is possible to accurately sense a change to the state where the use of the digital camera 501 can be started or a change to the state where the use of the digital camera 501 should be ended, and therefore to achieve a more comfortable usage environment.

According to the present embodiment, if the user is touching the camera body 2 when the camera body 2 is changed from a vertically laid state to a horizontally laid state or from a horizontally laid state to a vertically laid state in the power source off state with the quick image capturing mode set, the power source is automatically switched on. However, the power source may be switched on automatically if the camera body 2 is changed from a vertically laid state to a horizontally laid state or from a horizontally laid state to a vertically laid state while it is being sensed that the user touches the camera body 2 (that is, step SE1 and step SE2 are reversed). However, if the manner of the present embodiment is used, wasteful consumption of the electric power when the digital camera 501 is not used can be prevented by employing such a passive sensor as described in the first embodiment as the direction sensor 14.

### Sixth Embodiment

A sixth embodiment of the present invention will now be explained. Also in the present embodiment, the present invention is applied to a digital camera.

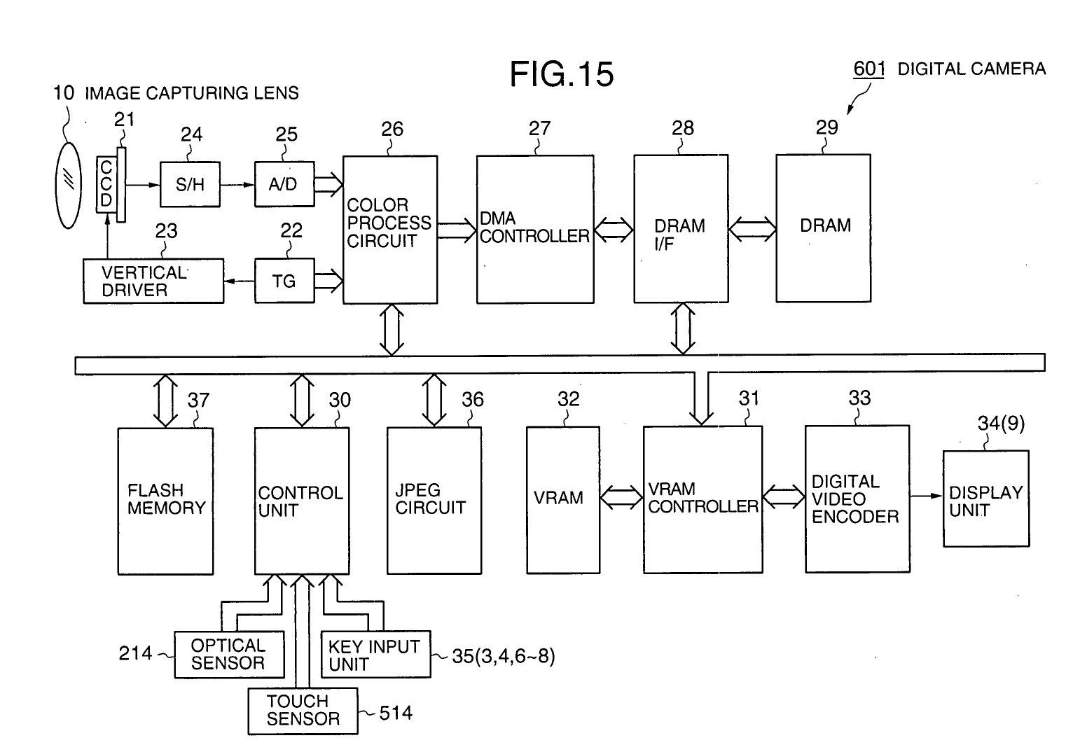

FIG. 15 is a block diagram showing the electric structure of a digital camera 601 according to the present embodiment. The digital camera 601 is structured such that the optical sensor 214 explained in the second and third embodiments in place of the direction sensor 14 is provided to the digital camera 501 explained in the fifth embodiment. The other structure than this is the same as the structure explained in the fifth embodiment.

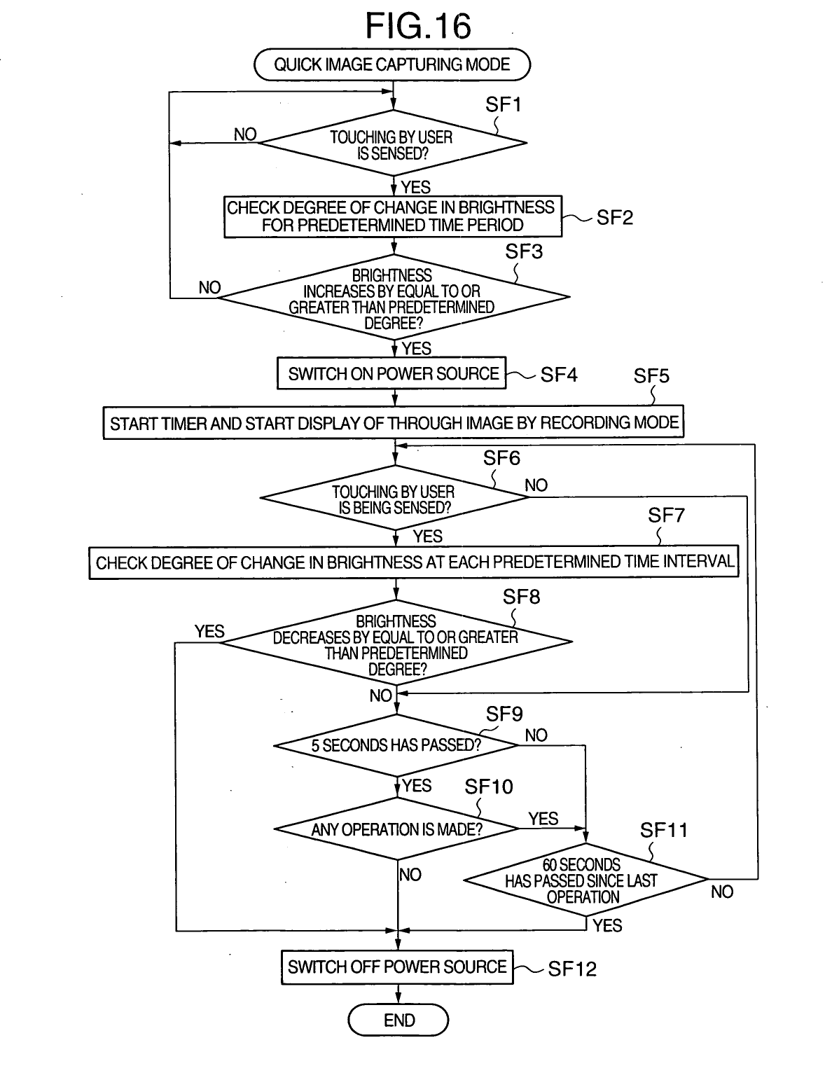

An operation according to the present invention of the digital camera 601 having the above-described structure will be explained with reference to the flowchart shown in FIG. 16. FIG. 16 shows an operation regarding the power source control of the digital camera 601 which is performed after the power source is switched off in the state where a quick image capturing mode is set by the user.

When the touch sensor 514 senses that the camera body 2 is touched by the user in the power source off state (step SF1: YES), the digital camera 601 checks the degree of change in the brightness sensed by the optical sensor 241 for a predetermined time period after the sensing of the touch (step SF2). If the brightness increases by equal to or greater than a predetermined degree (step SF3: YES), that is, if the vicinity of the camera body 2 becomes suddenly bright, this triggers the power source to be switched on (step SF4). Then, the timer starts counting the time after the power source is switched on, and the monitor display of a through image is immediately started by an operation for the recording mode (step SF5).

After the power source is switched on, the touch sensor 514 continues to sense touching by the user. While touching is being sensed (step SF6: YES), the digital camera 601 checks the degree of change in the brightness at each predetermined time interval (for example, every 0.5 second) (step SF7). When the brightness decreases by equal to or greater than a predetermined degree (step SF8: YES), that is, when the vicinity of the camera body 2 becomes suddenly dark, this triggers the power source to be switched off (step SF12).

Apart from these operations, if no operation is made during five seconds after the power source is switched on (step SF9: YES, step SF10: NO) regardless of whether the camera body 2 is touched by the user or not, the power source is immediately switched off (step SF12). Further, if no operation is made during sixty seconds (step SF11: YES), the power source is switched off by the general auto power off function (step SF12).

As described above, according to the digital camera 601 of the present embodiment, if the quick image capturing mode is pre-set, the power source is switched on automatically in response to the sensing of touching of the user's hand to the camera body 2 when the digital camera 601 is taken out from a bag or a pocket of clothes, etc. and in response to the sensing of the vicinity of the camera body 2 becoming suddenly bright. Therefore, by pre-setting the quick image capturing mode, the user can perform image capturing quickly at a desired timing without having to perform the power source switching on operation.

The power source is automatically switched off if no operation is made during five seconds after the power source is switched on. Therefore, the digital camera 601 is free from its power source being switched on by mistake when the user does not intend to use the digital camera 601, and free from such a power source on state by mistake being maintained. Thus, wasteful consumption of the electric power can be prevented and the battery life can be prolonged in the quick image capturing mode.

Further, according to the present embodiment, sudden darkening of the vicinity of the digital camera 601 while the user is touching the camera body 2, triggers the power source to be automatically switched off, even before the general auto power off function works due to that the time period during which no operation is made reaches 60 seconds. Accordingly, the user needs only to put the digital camera 601 in the bag or the pocket of the clothes, etc. and, conveniently, needs not to perform the power source switching off operation after using the digital camera 601, likewise the second to fifth embodiments. Further, as compared to the case where the power source is automatically switched off only by the general auto power off function, wasteful consumption of the electric power can be prevented more. This also contributes to the prolongation of the battery life in the quick image capturing mode. The auto power off function for switching off the power source in response to sensing results of the touch sensor 514 and the optical sensor 214 may solely be used in a state where the quick image capturing mode is not set. Also in this case, wasteful consumption of the electric power can further be prevented.

Further, also according to the present embodiment, unlike the first embodiment and second embodiment, a change of the environment of the digital camera 601 is sensed based on, as described above, the sensing results of the touch sensor 514 and the optical sensor 214, that is, based on information from different sources in order to determine a change to the state where the use of the digital camera 601 can be started or a change to the state where the use of the digital camera 601 should be ended. Accordingly, it is possible to accurately sense a change to the state where the use of the digital camera 601 can be started or a change to the state where the use of the digital camera 601 should be ended, and therefore to achieve a more comfortable usage environment.

Having mainly described the cases where the present invention is applied to the digital cameras, the present invention can also be applied to the other portable electronic apparatuses than digital cameras. In this case, by selectively providing such auto power on functions as in the above-described embodiments in accordance with the function and usage environment of the electronic apparatuses, the user can use the electronic apparatuses quickly at a desired timing without having to perform the power source switching on operation. By additionally providing the auto power off function, convenience of the use of the electronic apparatuses can be improved and the battery life can be prolonged.

In the third to sixth embodiments, there are shown the examples of digital cameras which use the direction sensor 14, the optical sensor 214, the vibration sensor 414, and the touch sensor 514 as first and second sensing units of the present invention. However, plural kinds of sensors other than these sensors may be used to sense a change of the environment of the digital cameras, etc. and thereby to determine a change to a state where the use of the digital cameras, etc. can be started or a change to a state where the use of the digital cameras, etc. should be ended.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-104715 filed on Apr. 9, 2003 and including specification, claims, drawings and summary. The disclosure of the above Japanese Patent Application is incorporated herein by reference in its entirety.

What is claimed is:

1. A portable electronic apparatus comprising:
a direction sensing unit which senses a vertical or horizontal direction which is along a direction of rotation about a predetermined axis of an apparatus body; and
a control unit which switches on a power source in response to that a direction of said apparatus body sensed by said direction sensing unit changes.

2. A portable electronic apparatus comprising:
a brightness sensing unit which senses brightness of a vicinity of an apparatus body; and
a control unit which switches on a power source in response to that the brightness sensed by said brightness sensing unit increases by equal to or greater than a predetermined degree during a predetermined time period.

3. The portable electronic apparatus according to claim 2, wherein
said control unit switches off said power source in response to that the brightness sensed by said brightness sensing unit decreases by equal to or greater than a predetermined degree during a predetermined time period.

4. A method of controlling a power source of a portable electronic apparatus, said method comprising
switching on a power source when brightness of a vicinity of an apparatus body increases by equal to or greater than a predetermined degree during a predetermined time period.

5. A portable electronic apparatus comprising:
a first and second sensing units which sense different information from each other; and
a control unit which switches on a power source in response to that sensing results showing predetermined changes in an environment are obtained from both of said first and second sensing units.

6. The portable electronic apparatus according to claim 5, wherein:
said first sensing unit is a brightness sensing unit which senses a brightness of a vicinity of an apparatus body;
said second sensing unit is a direction sensing unit which senses a vertical or horizontal direction which is along a direction of rotation about a predetermined axis of said apparatus body; and
said control unit switches on said power source in response to that a direction of said apparatus body sensed by said direction sensing unit changes during a predetermined time period after the brightness sensed by said brightness sensing unit increases by equal to or greater than a predetermined degree during another predetermined time period.

7. The portable electronic apparatus according to claim 6, wherein
said control unit switches off said power source in response to that the direction of said apparatus body sensed by said direction sensing unit changes.

8. The portable electronic apparatus according to claim 6, wherein
said control unit switches off said power source in response to that the brightness sensed by said brightness sensing unit decreases by equal to or greater than a predetermined degree during a predetermined time period after the direction of said apparatus body sensed by said direction sensing unit changes.

9. The portable electronic apparatus according to claim 5, wherein:
said first sensing unit is a vibration sensing unit which senses a vibration of an apparatus body;
said second sensing unit is a direction sensing unit which senses a vertical or horizontal direction which is along a direction of rotation about a predetermined axis of said apparatus body; and
said control unit switches on said power source in response to that a direction of said apparatus body sensed by said direction sensing unit changes during a predetermined time period after a vibration is sensed by said vibration sensing unit.

10. The portable electronic apparatus according to claim 9, wherein
said control unit switches off said power source in response to that the direction of said apparatus body sensed by said direction sensing unit changes during a predetermined time period after a vibration is sensed by said vibration sensing unit.

11. The portable electronic apparatus according to claim 5, wherein:
said first sensing unit is a touch sensing unit which senses that a predetermined portion of an apparatus body is touched by a user;
said second sending unit is a direction sensing unit which senses a vertical or horizontal direction which is along a direction of rotation about a predetermined axis of said apparatus body; and
said control unit switches on said power source in response to that a direction of said apparatus body sensed by said direction sensing unit changes while touching by the user is being sensed by said touch sensing unit.

12. The portable electronic apparatus according to claim 11, wherein
said control unit switches off said power source in response to that the direction of said apparatus body sensed by said direction sensing unit changes while touching by the user is being sensed by said touch sensing unit.

13. The portable electronic apparatus according to claim 5, wherein:
said first sensing unit is a touch sensing unit which senses that a predetermined portion of an apparatus body is touched by a user;
said second sensing unit is a brightness sensing unit which senses brightness of a vicinity of said apparatus body; and
said control unit switches on said power source in response to that the brightness sensed by said brightness sensing unit increases by equal to or greater than a predetermined degree during a predetermined time period while touching to said predetermined portion by the user is being sensed by said touch sensing unit.

14. The portable electronic apparatus according to claim 13, wherein said control unit switches off said power source in response to that the brightness sensed by said brightness sensing unit decreases by equal to or greater than a predetermined degree while touching by the user is being sensed by said touch sensing unit.

15. The portable electronic apparatus according to claim 5, wherein
said control unit switches off said power source in response to that no operation is made during a predetermined time period after said power source is switched on.

16. A method of controlling a power source of a portable electronic apparatus, said method comprising
switching on a power source when a control unit determines that a predetermined change in an environment occurs to an apparatus, based on information from first and second sensing units which are different from each other.

17. The method according to claim 16, wherein:
said first sensing unit is a brightness sensing unit which senses brightness of a vicinity of an apparatus body;
said second sensing unit is a direction sensing unit which senses a vertical or horizontal direction which is along a direction of rotation about a predetermined axis of said apparatus body; and
said control unit switches on said power source in response to that a direction of said apparatus body sensed by said direction sensing unit changes during a predetermined time period after the brightness sensed by said brightness sensing unit increases by equal to or greater than a predetermined degree during another predetermined time period.

18. The method according to claim 16, wherein:
said first sensing unit is a vibration sensing unit which senses a vibration of an apparatus body;
said second sensing unit is a direction sensing unit which senses a vertical or horizontal direction which is along a direction of rotation about a predetermined axis of said apparatus body; and
said control unit switches on said power source in response to that a direction of said apparatus body sensed by said direction sensing unit changes during a predetermined time period after a vibration is sensed by said vibration sensing unit.

19. The method according to claim 16, wherein:
said first sensing unit is a touch sensing unit which senses that a predetermined portion of an apparatus body is touched by a user;
said second sending unit is a direction sensing unit which senses a vertical or horizontal direction which is along a direction of rotation about a predetermined axis of said apparatus body; and
said control unit switches on said power source in response to that a direction of said apparatus body sensed by said direction sensing unit changes while touching by the user is being sensed by said touch sensing unit.

20. The method according to claim 16, wherein
said first sensing unit is a touch sensing unit which senses that a predetermined portion of an apparatus body is touched by a user;
said second sensing unit is a brightness sensing unit which senses brightness of a vicinity of said apparatus body; and
said control unit switches on said power source in response to that the brightness sensed by said brightness sensing unit increases by equal to or greater than a predetermined degree during a predetermined time period while touching to said predetermined portion by the user is being sensed by said touch sensing unit.
